(19) United States
(12) Patent Application Publication
(10) Pub. No.: US 2014/0202419 A1
(43) Pub. Date: Jul. 24, 2014

(54) ROTARY PISTON ENGINE

(71) Applicant: AVL List GmbH, Graz (AT)

(72) Inventors: Alexander Machold, Wolfsberg (AT); Andreas Ennemoser, Graz (AT); Josef Ruetz, Graz (AT)

(73) Assignee: AVL List GmbH, Graz (AT)

(21) Appl. No.: 14/222,323

(22) Filed: Mar. 21, 2014

Related U.S. Application Data
(63) Continuation of application No. PCT/EP2012/005127, filed on Dec. 12, 2012.

(30) Foreign Application Priority Data
Dec. 19, 2011 (AT) A 50334/2012

(51) Int. Cl. F02B 55/14

(52) U.S. Cl. CPC F02B 55/14
USPC 123/210

(57) ABSTRACT

A rotary piston engine is disclosed. In one aspect, the engine includes a rotary piston rotating in a housing. The engine also includes a piston flank wall extending at least between two apex edges adjacent on the circumferential wall of the piston. The engine further includes a combustion chamber formed between the piston flank wall, an inner circumferential wall of the housing, and inner side walls of the housing, wherein the spark plug is connected to the combustion chamber by at least one spark plug channel. The spark plug channel has a substantially circular, elliptical or slot-like formed cross-section and the spark plug is arranged in a spark plug cavity having a larger diameter than the spark plug channel. The volume of the spark plug cavity is arranged relatively to thee spark plug channel substantially at the rear side, seen in the direction of rotation.

### CROSS-REFERENCE TO RELATED APPLICATIONS

This application is a continuation application, and claims the benefit under 35 U.S.C. §§120 and 365 of PCT Application No. PCT/EP2012/005127, filed on Dec. 12, 2012, which is hereby incorporated by reference. PCT/EP2012/005127 also claimed priority from Austrian Patent Application No. A 50334/2012 filed on Dec. 19, 2011, which is hereby incorporated by reference.

### BACKGROUND

1. Field

The described technology generally relates to a rotary piston engine.

Description of the Related Technology

2. A housing of a vehicle is an element which is generally mounted in a fixed position relatively to the vehicle or suspended within the vehicle in a vibration-damping way, for instance resiliently, forming a hollow space for accommodating a rotary piston. The rotary piston is a centrically or eccentrically rotating element which is able to mechanically interact at its surface with a gas which is present in its environment, for example, in the way that the rotating element exerts a pressure on the gas by its movement and thus compresses it, or vice versa, in the way that the gas exerts a pressure on the rotating element and thus moves it.

The rotary piston engine can be deployed as the only drive in a motor vehicle, but can, for instance, also be provided additionally to an electric motor in a hybrid drive. In the latter case, the output shaft of the rotary piston engine can either directly be connected to the mechanical drive train, or the output shaft is connected to an electric generator which generates electrical energy for operating the electric motor and/or for charging a battery.

As part of a hybrid drive, the rotary piston engine can also be dimensioned relatively small compared to the electric motor, and, in connection with a generator, only serve as an additional power source in order to enable continued operation of the motor vehicle even in the case of an empty battery, in this way increasing the operating distance and thus the operational safety and availability of the motor vehicle. In this case, also the term of a deployment as a “range extender” is used.

Here, the rotary piston can substantially have the same cross-section everywhere in axial direction and has at least two apex edges on its circumferential wall, with a piston flank wall extending at least between two apex edges which are adjacent on the circumferential wall of the piston. The rotary piston can have three apex edges and is called a triangular piston in this case. Furthermore, the rotary piston has two side faces which are oriented parallel to its plane of rotation.

Moreover, the piston flank wall of the rotary piston has a so-called piston recess, i.e. a recess-like deepening in the surface of the piston flank wall.

The rotary piston engine can operate as a combustion engine with a fuel-air mixture which is either drawn into the combustion space and is compressed there, or the fuel is directly injected into the combustion space. Here, the combustion space is formed between the circumferential wall of the piston and the inner wall of the housing, the inner wall typically having the form of a trochoid.

The combustion space is separated into several combustion chambers, which are dislocated along with the rotation and change their sizes, by the apex edges of the rotary piston during the eccentric rotation of the rotary piston. For this purpose, apex seals for sealing the combustion chambers which are formed on either side of the apex edge against each other can be arranged along the apex edges.

In the case of a fuel-compressing engine, the fuel-air mixture is taken into one of the combustion chambers, is compressed there, and is ignited by means of at least one spark plug, and the generated combustion gases are subsequently discharged from the combustion space. The spark plug is a device that can emit a spark which is suitable for igniting a combustible gas, in particular a fuel-air mixture, at a predetermined point of time.

The rotary piston engine can have two spark plugs, as this leads to a particularly favorable operating point. In order to adapt the operational characteristics of the rotary piston engine, one or the other spark plug is ignited first, depending on the operating point.

In the rotary piston engine considered, the spark plugs are arranged in an inner circumferential wall of the housing, and can be centered with respect to the axial extension of the rotary piston and the combustion space. An arrangement of the spark plugs in the front or rear inner side wall of the housing, seen in axial direction, is also conceivable, but cannot be realized so easily, because at these walls usually parts of the water cooling of the rotary piston engine are arranged, and therefore there is not enough accommodation space available for the spark plugs and their connections.

Each spark plug is arranged in a spark plug cavity in or adjacent to the inner circumferential wall of the housing and is connected to the combustion space by at least one spark plug channel. The spark plug channel can be an elongated, cavity which is suitable for transmitting the—non-ignited or ignited—fuel-air mixture to or from a spark plug.

An intake channel for the fuel-air mixture is also arranged in an inner circumferential wall of the housing. The intake channel can be an elongated, cavity which is suitable for feeding the non-ignited fuel-air mixture into the combustion space. The intake channel can differ significantly in its form and diameter from the spark plug channels. The intake channel can be arranged at the side of the inner circumferential wall of the housing opposite the spark plugs.

Correspondingly, an exhaust channel for the exhaust fumes generated in the combustion space is arranged at the inner circumferential wall of the housing, for example, at the side of the inner circumferential wall of the housing opposite the spark plugs as well.

The relative position and the form of said elements of the rotary piston engine substantially contribute to the course of action of the combustion process within the combustion space and thus to the degree of efficiency of the rotary piston engine.

Certain relative positions between elements of the rotary piston engine also result from requirements for the functional capability and safety of the combustion process. For instance, it must be guaranteed that in no rotational position of the rotary piston both the opening of the intake channel in the inner circumferential wall of the housing and the opening of at least one of the spark plug channels in the inner circumferential wall of the housing are, in each case completely or partially, connected to the same combustion chamber at the same time.

Otherwise, for example, in the case of a spark failure, the pressure of the ignited fuel-air mixture in this combustion chamber could propagate back into the intake channel, by which a compression wave and a blast could be generated there, which could substantially disturb the running smoothness of the rotary piston engine or even lead to its being damaged.

DE 2 344 690 A1 discloses a rotary piston engine with at least one rotary piston. There, it is proposed to design the opening for the accommodation of the spark plug as a slot whose longitudinal extension is oriented in parallel to the longitudinal direction of the apex seal. Here, the spark plug cavity is symmetrical with respect to its volume in the rotational direction of the rotary piston.

JP 56-059 934 U discloses a rotary piston engine with two ignition devices whose shooting channels have different diameters. The respective volumes of these shooting channels are—in particular in the direction of rotation of the rotary piston—distributed symmetrically.

JP 61-178 035 U discloses a design of the opening of a shooting channel in the race of a rotary piston engine according to the Wankel design. Here, the opening has the form of an upright eight in the running direction of the rotary piston. The ignition device is arranged centrically in the cavity which also forms the shooting channel.

U.S. Pat. No. 4,755,116 A discloses a rotary piston engine with two ignition devices is known, wherein the opening of the second shooting channel is larger than the opening of the first shooting channel. The spark plug cavity below the ignition device is formed symmetrically.

JP 52 049 204 U discloses a symmetrical design of the spark plug cavity which can also be observed with the rotary piston engine.

### SUMMARY OF CERTAIN INVENTIVE ASPECTS

One inventive aspect is a rotary piston engine having at least one one-piece or multi-piece rotary piston rotating in a housing around a centrically or eccentrically supported axle, having substantially the same cross-section everywhere in axial direction, and having at least two apex edges on its circumferential wall, wherein a piston flank wall extends at least between two apex edges which are adjacent on the circumferential wall of the piston, with at least one spark plug which is arranged in an inner circumferential wall of the housing and with an intake channel which is arranged in an inner circumferential wall of the housing, with a combustion chamber being formed between the piston flank wall, an inner circumferential wall of the housing and inner sidewalls of the housing, and the spark plug being connected to the combustion chamber by at least one spark plug channel.

Another aspect is to improve the relative position and the form of the elements of the rotary piston engine, for example, of the spark plug channels, in view of the function, in particular in view of the degree of efficiency, of the rotary piston engine.

Another aspect is a rotary piston engine, wherein in no rotational position of the rotary piston, both the opening of the intake channel at the inner circumferential wall of the housing as well as the opening of at least one of the spark plug channels in the inner circumferential wall of the housing are, in each case completely or partially, connected to the same combustion chamber at the same time. Under this condition, according to some embodiments, the distance between the opening of the intake channel and the opening of the spark plug channel which is nearest to the opening of the intake channel, measured along the inner circumferential wall of the housing, is minimum or approximately minimum.

When the inner circumferential wall of the housing has the form of a trochoid and the spark plug considered is arranged on the same side of the shorter axis of symmetry of the trochoid as the intake channel, the arrangement according to some embodiments means that the distance between the opening of the spark plug channel considered and this axis of symmetry is maximum or approximately maximum.

In the functional sequence of a rotary piston engine, the arrangement according to some embodiments means that an apex edge of the rotary piston passes the opening of the spark plug channel considered in the moment or immediately after the moment in which the apex edge trailing behind this apex edge in the direction of rotation completely passes the intake channel, with the two apex edges considered defining the two ends of the combustion chamber.

Due to the arrangement according to some embodiments, the ignition of the fuel-air mixture can occur as early as possible, thus increasing the degree of efficiency of the rotary piston engine.

Furthermore, in a rotary piston engine according to some embodiments, at least one spark plug channel can have a cross-section which is substantially circular, elliptical, or formed in a slot-like way. It turned out that also such variations of the cross-section of the spark plug channel can yield advantageous effects for the combustion of the fuel-air mixture.

In some embodiments, the spark plug is arranged in a spark plug cavity which has a larger diameter than that of at least one spark plug channel.

In some embodiments, the volume of the spark plug cavity is arranged relatively to at least one spark plug channel predominantly at the rear side seen in the direction of rotation. In this way, the fluid flow in the combustion space supports the flame core in the spark plug channel in its direction of movement into the combustion space; thus supporting an undisturbed burning of the flame from the spark plug channel into the combustion space. A further positive effect of this variant is that the fuel-air mixture is homogenously fed to the spark plug in the spark plug cavity.

In some embodiments, the spark plug cavity has a narrowing, for example, a conically tapered side face, with one end of at least one spark plug channel lying completely or partially within this side face.

In some embodiments, the spark plug cavity is oriented substantially parallel to at least one spark plug channel.

The last-mentioned variants can lead to an advantageous and efficient course of events of the ignition and combustion of the fuel-air mixture.

In some embodiments, at least one apex seal for sealing the combustion chambers formed on either side of the apex edge against each other is arranged along at least one apex edge of the circumferential wall of the piston, and the apex seal completely or approximately completely covers the outlet opening of the spark plug channel or the outlet openings of all spark plug channels belonging to one spark plug into the combustion space when passing the outlet opening(s).

This can yield a complete separation of the two combustion chambers considered by the apex seal in each rotational position of the rotary piston by avoiding that the two combustion chambers are indirectly connected to each other via one or more spark plug channels and/or via the spark plug cavity when the apex seal passes these spark plug channels. This could lead to fuel-air mixture which is already burning, supported by the pressure difference in the two combustion chambers, unintentionally getting from one combustion chamber into the other and mixing there with fuel-air mixture which is still uncombusted and also igniting this fuel-air mixture, in this way disturbing the combustion process and thus in turn decreasing the efficiency of the rotary piston engine.

### BRIEF DESCRIPTION OF THE DRAWINGS

FIG. 1 is a cross-sectional view of a rotary piston engine according to some embodiments.

FIG. 2is an abstracted cross-sectional view of those elements associated with the kinematics of the rotary piston engine as points and lines.

FIG. 3illustrates a spark plug channel and a spark plug cavity according to some embodiments.

FIG. 4a is a schematized view of the flow characteristics in a typical spark plug channel and in a typical spark plug cavity.

FIG. 4b is a schematized view of the flow characteristics in a spark plug channel and in a spark plug cavity according to some embodiments.

### DETAILED DESCRIPTION OF CERTAIN INVENTIVE EMBODIMENTS

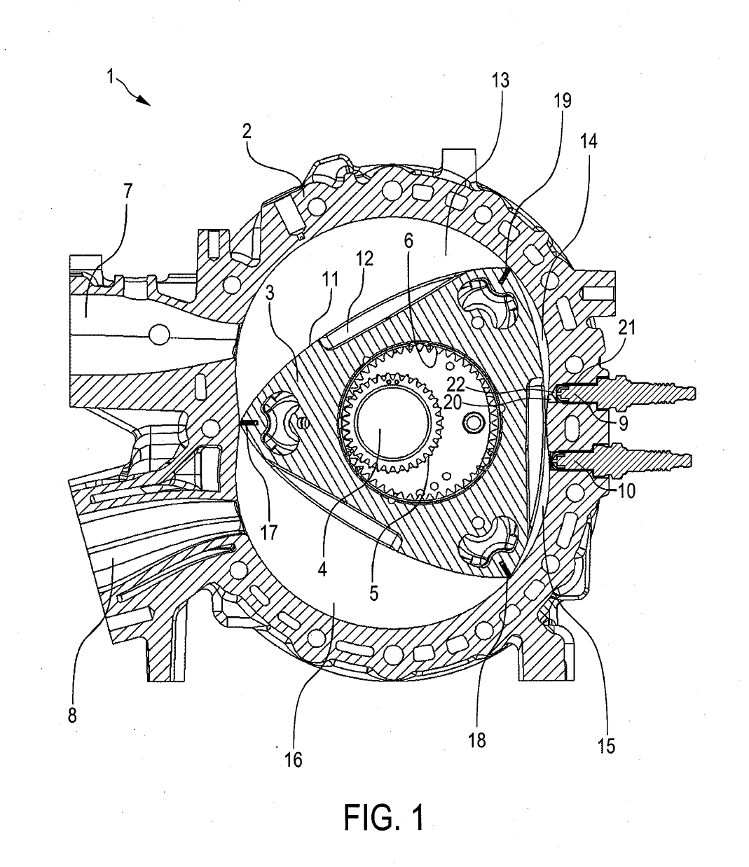

Referring to FIG. 1, a mixture-compressing rotary piston engine 1 includes a housing 2 with a plurality of cooling channels, an intake opening 7 for the fuel-air mixture and an exhaust opening 8 for the exhaust fumes. The rotary piston engine 1 also includes a rotary piston 3 having three apex edges and accordingly three piston flank walls 11 with one piston recess 12 each. Radially outwardly protruding apex seals 17, 18, 19 are mounted at the apex edges of the rotary piston 3. The rotary piston 3 eccentrically rotates around a fixed axle 4 with an outer serration 5, rolling on the outer serration 5 by means of an inner serration 6. Here, the rotary piston 3 rotates clockwise.

Two spark plugs are arranged approximately diametrically opposite intake opening 7 and exhaust opening 8 in the wall of the housing at the positions denoted by 9 and 10. In the interior of the housing 2, four combustion chambers 13, 14, 15, and 16 (clockwise again) are defined by the rotational position of the rotary piston 3, these combustion chambers being allocated in this order to the suction, compression, ignition and exhaust cycle, respectively.

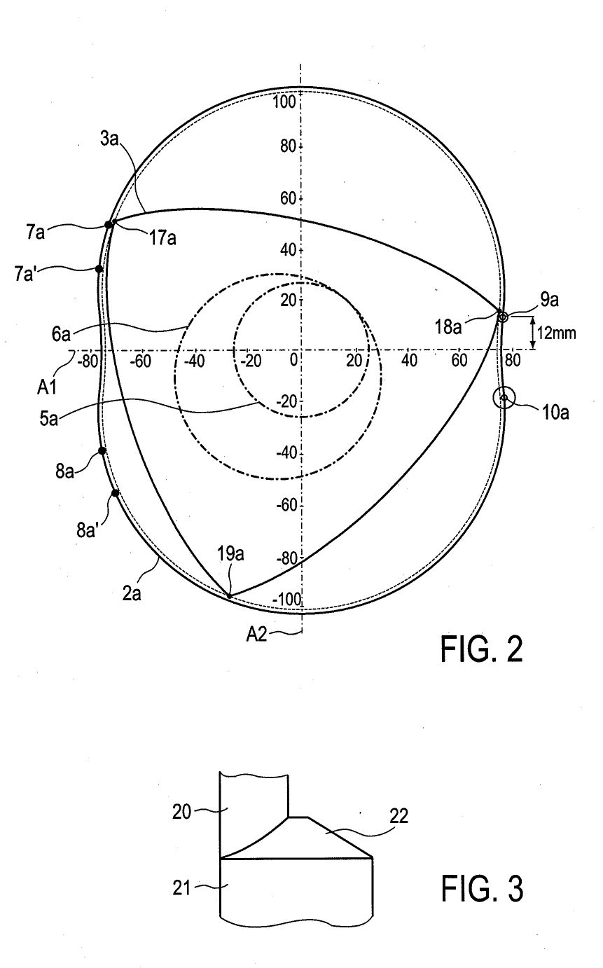

FIG. 2 shows different elements of the rotary piston engine 1 in an abstracted cross-sectional view as points or lines, which elements define the kinematics of the rotary piston engine 1, namely the inner circumferential wall of the housing in the form of a trochoid 2a, the outer circumferential wall 3a of the rotary piston 3 and the outer edge 5a of the fixed gear on which the inner edge 6a of the rotary piston 3 is rolling. Furthermore, the front and rear edge point 7a and 7a′, seen in the direction of rotation, of the intake opening on the trochoid, the corresponding edge points 8a and 8a′ of the exhaust opening on the trochoid and the positions 9a and 10a of the spark plug channel of the rear and front spark plugs can be seen. Finally, the short (in FIG. 2 horizontally oriented) and the long (in FIG. 2 vertically oriented) axes of the trochoid are denoted as A1 and A2, respectively.

In FIG. 2, the rotary piston 3 can have the following position: The intake channel has just been closed, i.e., the compression combustion chamber 14 has no more connection to the intake channel (apex seal 17 passes the front edge point 7a of the intake opening). At the same time, however, a compression combustion chamber 14 has no connection to the rear spark plug channel 9a yet (apex seal 18 is just about to pass spark plug channel 9a). In the FIG. 2 embodiment, the rear spark plug channel 9a is arranged in such a way that its distance from the short axis A1 of the trochoid of 12 mm is nearly maximum. In a typical arrangement, this distance used to be only about 8.3 mm. In this way, the ignition of the rear spark plug can occur as early as possible.

FIG. 3 shows the form of the space in the inner circumferential wall of the housing of rotary piston 3, in which in this embodiment the rear spark plug 9 is accommodated. Spark plug 9 is arranged in a spark plug cavity 21 having a substantially elliptical cross-section and a conical side face 22. The conical side face 22 is penetrated by one end of the spark plug channel 20, with the spark plug channel 20 also having an elliptical cross-section and being oriented parallel to the longitudinal direction of the spark plug cavity 21. The spark plug channel 20 is arranged eccentrically with respect to the spark plug cavity 21. For example, the outer edge of the spark plug cavity 21 and the spark plug channel 20 lie on the same straight line.

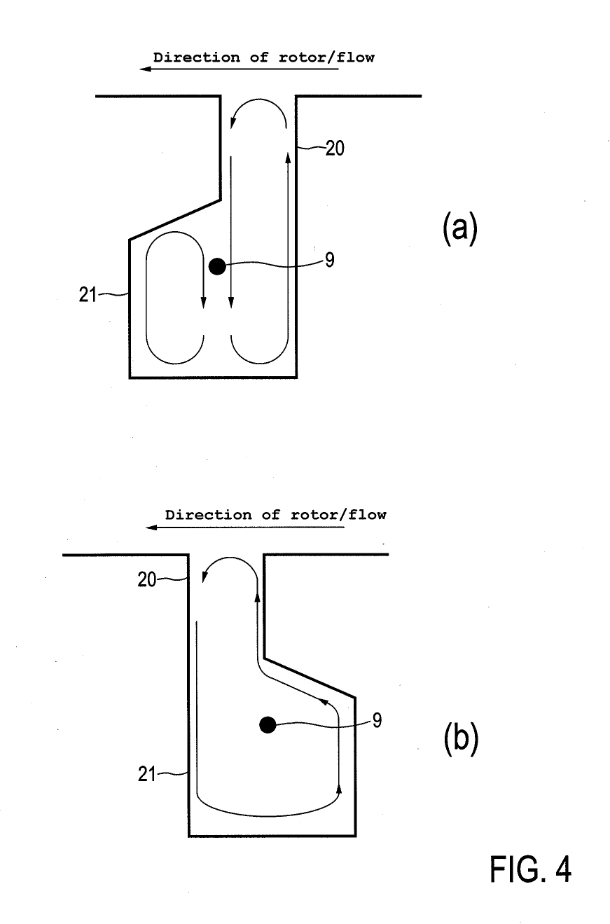

As can be seen in FIG. 3, the volume of spark plug cavity 21 relatively to spark plug channel 20 is predominantly arranged at the rear, seen in the direction of rotation. In this way, the flow characteristics within these two spaces is decisively improved. This will be explained in detail in the following, using FIG. 4.

FIG. 4a shows a typical spark plug cavity 21 arranged relative to the spark plug channel 20 predominantly at the front, seen in the direction of rotation. In FIG. 4a, also the position of the ignition point of the spark plug 9 is depicted. Furthermore, the direction of movement of the rotor, which at the same time corresponds to the direction of flow of the fuel-air mixture in the combustion space, is specified by a straight arrow.

In FIG. 4a, the flow movement presses the flame core against its desired direction of propagation back into the spark plug channel 20. Two circulating flows which are independent of each other result in the spark plug cavity 21 and in the spark plug channel 20, indicated in the figure by two rings consisting of circulating arrows. This obstructs an undisturbed burning of the flame out of the spark plug channel 20 into the combustion space.

FIG. 4b is a schematized view of the flow characteristics in a spark plug channel and in a spark plug cavity according to some embodiments. In FIG. 4b, the spark plug cavity 21 is located relatively to the spark plug channel 20 substantially at the rear, seen in the direction of rotation, the flame core is supported in its movement in the direction of the combustion space by the flow movement. This supports an undisturbed burning of the flame out of the spark plug channel 20 into the combustion space. Since only a single circulating flow results in the spark plug cavity 21 and in the spark plug channel 20, indicated in the figure by a ring of circulating arrows again, this results in the further advantage that the mixture is homogenously fed to the spark plug 9.

In this embodiment, the larger diameter of the elliptical spark plug channel 20 is about 4 mm and is less than half as large as the larger diameter of the elliptical spark plug cavity 21. This diameter difference has the effect that the flow from the relatively small spark plug channel 20 propels the turbulence of the fuel-air mixture rotating in spark plug cavity 21. Depending on the operating point of the rotary piston engine 1 chosen, the spark plug channel 20 can be chosen with a certain, for example, circular, elliptical or slot-like formed, cross-section.

Furthermore, it is possible to connect the spark plug cavity 21 containing the spark plug 9 with the combustion space by two spark plug channels. In this case, however, it must be observed that in a position of the rotary piston 3 in which the openings of the two spark plug channels into the combustion space belong to different combustion chambers, a sort of “short circuit” between the two combustion chambers would result. At the same time, there can be a big pressure difference between the two combustion chambers. This can lead to an undesired “burning back” from one combustion chamber into the other.

This “short circuit effect” can—both in the case of one spark plug channel and of two spark plug channels—be avoided by making each apex seal 17, 18, 19 broad enough to completely or approximately completely cover the outlet opening(s) of the or the two spark plug channel(s) when passing the spark plug channel(s), so that no parts of these outlet openings belonging to different combustion chambers are “opened” at the same time.

While the above description has pointed out features of various embodiments, the skilled person will understand that various omissions, substitutions, and changes in the form and details of the device or process illustrated may be made without departing from the scope of the appended claims.

What is claimed is:

1. A rotary piston engine having at least one one-piece or multi-piece rotary piston configured to rotate in a housing around a centrically or eccentrically supported axle, having substantially the same cross-section everywhere in an axial direction, and having at least two apex edges on its circumferential wall, the rotary piston engine comprising:
a piston flank wall extending at least between two apex edges which are adjacent on the circumferential wall of the piston, with at least one spark plug which is arranged in an inner circumferential wall of the housing; and
a combustion chamber formed between the piston flank wall, an inner circumferential wall of the housing, and inner side walls of the housing, wherein the spark plug is connected to the combustion chamber via at least one spark plug channel,
wherein the spark plug channel has a substantially circular, elliptical or slot-like formed cross-section,
wherein the spark plug is arranged in a spark plug cavity which has a larger diameter than the spark plug channel,
and wherein the volume of the spark plug cavity is arranged relatively to the spark plug channel substantially at the rear side, seen in the direction of rotation.

2. The rotary piston engine according to claim 1, wherein the spark plug cavity has a narrowing, conically tapered, side face and wherein one end of the spark plug channel lies completely or partially within this side face.

3. The rotary piston engine according to claim 2, wherein the spark plug cavity is orientated substantially parallel to the spark plug channel.

4. The rotary piston engine according to claim 3, wherein at least one apex seal for sealing the combustion chambers which are formed on either side of the apex edge against . each other is arranged along at least one apex edge of the rotary piston and wherein the apex seal completely or substantially completely covers an outlet opening of the spark plug channel or outlet openings of all spark plug channels belonging to one spark plug into the combustion space when passing the outlet opening(s).

5. The rotary piston engine according to claim 2, wherein at least one apex seal for sealing the combustion chambers which are formed on either side of the apex edge against each other is arranged along at least one apex edge of the rotary piston and wherein the apex seal completely or approximately completely covers an outlet opening of the spark plug channel or outlet openings of all spark plug channels belonging to one spark plug into the combustion space when passing the outlet opening(s).

6. The rotary piston engine according to claim 1, wherein at least one apex seal for sealing the combustion chambers which are formed on either side of the apex edge against each other is arranged along at least one apex edge of the rotary piston and wherein the apex seal completely or approximately completely covers an outlet opening of the spark plug channel or outlet openings of all spark plug channels belonging to one spark plug into the combustion space when passing the outlet opening(s).

7. The rotary piston engine according to claim 1, wherein the spark plug cavity is orientated substantially parallel to the spark plug channel.
